(19) United States
(12) Patent Application Publication
(10) Pub. No.: US 2013/0048123 A1
(43) Pub. Date: Feb. 28, 2013

(54) SEGMENTED POSITIONING STRUCTURE OF A CERAMIC SHUNT VALVE

(71) Applicant: Mei-Li CHEN, Taichung City (TW)

(72) Inventor: Mei-Li CHEN, Taichung City (TW)

(73) Assignee: KUCHING INTERNATIONAL LTD., Taichung City (TW)

(21) Appl. No.: 13/558,631

(22) Filed: Jul. 26, 2012

(30) Foreign Application Priority Data
Aug. 29, 2011 (TW) 100246084

(51) Int. Cl. F16K 11/06

(52) U.S. Cl. 137/625.15

(57) ABSTRACT

A segmented positioning structure of a ceramic shunt valve having a shell, a plurality of segmented coupling portions, a water segregator, a segmented positioning plate, a plurality of segmented positioning portions and an elastic supporting member. The elastic supporting member is installed between the rotational positioning seat of the water segregator and the segmented positioning plate, so that the segmented positioning plate is elastically braced in an elastic floating state, and a spacing edge is located beside the locating rod for limitation of the segmented positioning plate. When the braking shaft lever is rotated, the segmented positioning plate will be in a floating state under the elastic bracing of elastic supporting member, in tune with the interlocking and disengagement state of the segmented positioning portion and segmented coupling portion. This could realize excellent elastic locking effect and reduce the abrasion between the segmented positioning portion and segmented coupling portion.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a ceramic shunt valve, and more particularly to an innovative one which is designed with a segmented positioning structure.

2. Description of Related Art Including Information Disclosed Under 37 CFR 1.97 and 37 CFR 1.98.

A shunt valve is used to transfer the incoming water streams to various flow paths, allowing to select the flow paths at your discretion. A conventional shunt valve comprises a shell, a braking shaft lever, a water segregator, a water inlet and at least two water outlets. With the use of the braking shaft lever, the water stream from the inlet could be discharged from a preselected outlet via the shunt valve, thus realizing water diversion control based on the flow directions.

When the braking shaft lever is applied to the shunt valve for regulating streams, the braking shaft lever is purely rotated for regulation purposes. When it is intended for regulating the diversion by rotating the braking shaft lever of the shunt valve, the user may find it difficult to fine-tune to the preset flow paths, leading to possible leakage to other flow paths.

Moreover, despite of the rotary segmented positioning design of the braking shaft lever on a conventional shunt valve, the interlocking portion is slightly protruded and directly formed on a coupling plate and its corresponding valve casing driven by the bottom of the braking shaft lever, then the interlocking effect is realized by the elasticity of plastics. However, the following shortcomings are observed during actual applications:

First, as the interlocking portion is slightly protruded and directly formed on a coupling plate and its corresponding valve casing, the user may find it too tight and rigid for rotation and interlocking in the case of extreme protrusion, or too loose against interlocking in the case of slight protrusion.

Second, the interlocking portion is vulnerable to rapid abrasion and damage arising from the repeated actuation between said coupling plate and valve casing, thus resulting in shorter service life and lack of applicability.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

When the braking shaft lever is rotated for regulating the water diversion direction, the segmented positioning plate is in a floating state under the elastic bracing of elastic supporting member, in tune with the interlocking and disengagement state of the segmented positioning portion and segmented coupling portion. Hence, this could realize excellent elastic locking effect, so as to further improve the operating properties of the ceramic shunt valve.

Based on the technical characteristics wherein the segmented positioning portion could float elastically, elastic interlocking and disengagement between the segmented positioning portion and the segmented coupling portion could be realized, helping to reduce the abrasion and extend the service life of segmented positioning structure of ceramic shunt valve with better applicability.

Based on the structural design wherein a spacing edge is located beside the locating rod, the segmented positioning plate could be prevented from being disengaged from the braking shaft lever. Further, the segmented positioning plate could be assembled into the braking shaft lever with stable limitation effect. In the process of assembly, the segmented positioning plate could not be discretionarily disengaged from the braking shaft lever, thus bringing about more smooth and convenient assembly.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled perspective view of the preferred embodiment of the present invention.

FIG. 2 is a partially exploded perspective view of the preferred embodiment of the present invention.

FIG. 3 is an assembled sectional view of the preferred embodiment of the present invention.

FIG. 4 is a schematic actuating view of the stream direction of the ceramic shunt valve of the present invention.

FIG. 5 is a perspective view of another preferred embodiment of the present invention illustrating the segmented positioning portion and the segmented coupling portion.

FIG. 6 is a perspective view of another preferred embodiment of the present invention illustrating the segmented positioning portion and the segmented coupling portion.

FIG. 7 is a schematic view of the present invention wherein the upper end surface located on the top of the shell is designed into a combined pattern.

### DETAILED DESCRIPTION OF THE INVENTION

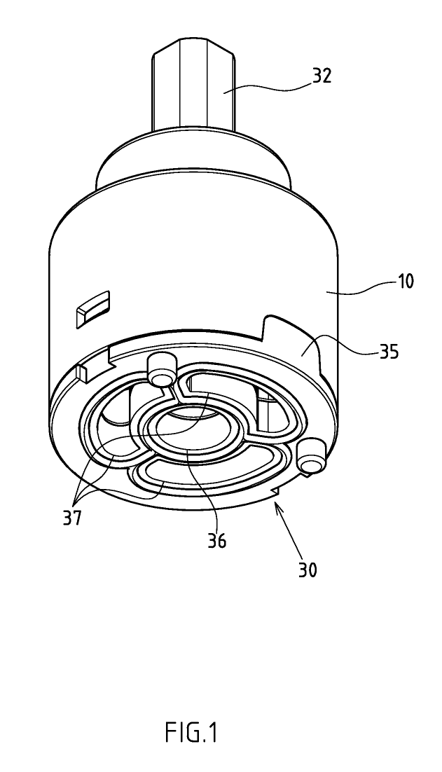

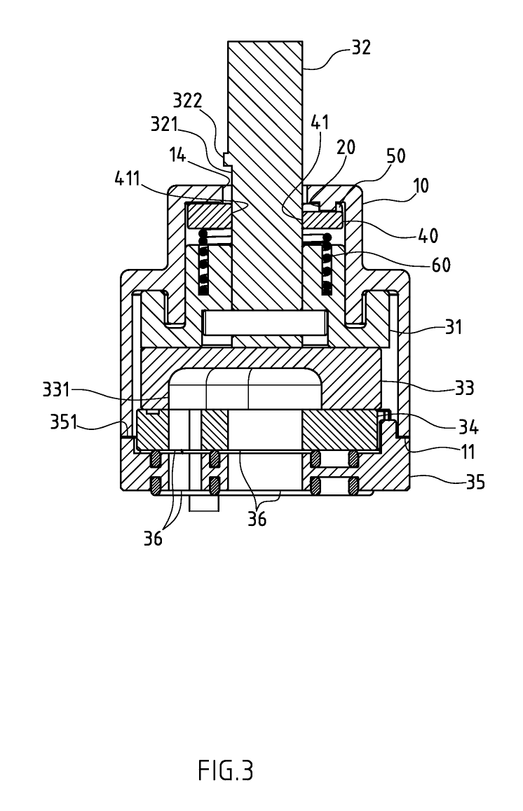

FIGS. 1-3 depict preferred embodiments of a segmented positioning structure of ceramic shunt valve of the present invention, which, however, are provided for only explanatory purpose for patent claims.

Said segmented positioning structure of ceramic shunt valve comprises a shell 10, wherein a bottom edge 11 is formed at its bottom and a holding space 12 formed internally. An upper end surface 13 with a through-hole 14 is set on the top of the shell 10.

A plurality of segmented coupling portions 20 are arranged at interval onto the inner side of the upper end surface 13 of the shell 10 in an annular pattern.

A water segregator 30 whose upper end is provided with a rotational positioning seat 31, and a braking shaft lever 32 is installed on the top end surface. At least one locating rod 321 is set on the periphery of the braking shaft lever 32, with the bottom connected to a rotational valve plate 33. A spacing edge 322 is located beside the locating rod 321. The lower end surface of the rotational valve plate 33 is abutted with a fixed valve plate 34 to form a flow channel 331. A water inlet 36 is installed on the end surface of the fixed valve plate 34, and at least two water outlets 37 are set on the periphery of the water inlet 36. A pedestal 35 located on the bottom of the water segregator 30 is abutted with the fixed valve plate 34. An upper flange 351 arranged on the upper end of the pedestal 35 is interlocked with the bottom edge 11 of the shell 10, so that the water segregator 30 could be installed in the holding space 12. A water inlet 36 and a water outlet 37 correspondingly to the fixed valve plate 34 are set on the bottom of the pedestal 35.

A segmented positioning plate 40 is provided with a directional sleeved hole 41 opened centrally for assembly on the locating rod 321 of the braking shaft lever 32. So, the segmented positioning plate 40 could rotate along with the braking shaft lever 32. Further, the spacing edge 322 beside the locating rod 321 could prevent the segmented positioning plate 40 from being disengaged from the braking shaft lever 32. With this design, the segmented positioning plate 40 could be assembled into the braking shaft lever 32 with stable limitation effect. In the process of assembly, the segmented positioning plate 40 could not be discretionarily disengaged from the braking shaft lever 32, thus bringing about more smooth and convenient assembly.

A plurality of segmented positioning portions 50 are set at interval around the directional sleeved hole 41 of the segmented positioning plate 40 in an annular pattern.

An elastic supporting member 60 is installed between the rotational positioning seat 31 of the water segregator 30 and the segmented positioning plate 40, so that the segmented positioning plate 40 is elastically supported in an elastic floating state.

Of which, the segmented positioning portion 50 is designed into a radial concave pattern by taking the segmented positioning plate 40 as its center, and the segmented coupling portion 20 is designed into a radial convex pattern by taking the through-hole 14 of the shell 10 as its center, so that the segmented positioning portion 50 and the segmented coupling portion 20 could be correspondingly interlocked.

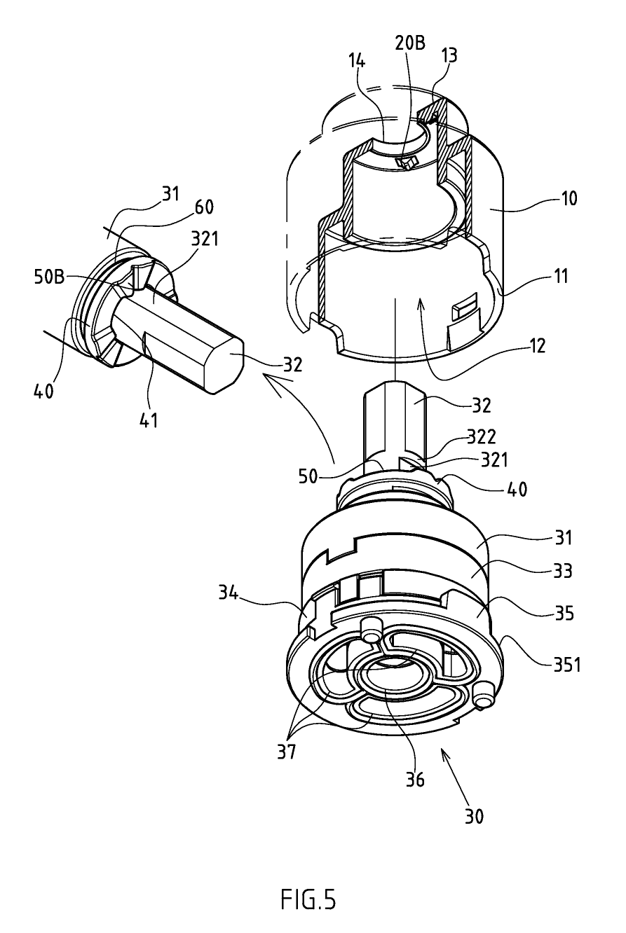

Referring to FIG. 5, the segmented positioning portion 50B is designed into a radial double-convex pattern by taking the segmented positioning plate 40 as its center, and the segmented coupling portion 20B is designed into a radial convex pattern by taking the through-hole 14 of the shell 10 as its center, so that the segmented positioning portion 50B and the segmented coupling portion 20B could be correspondingly interlocked.

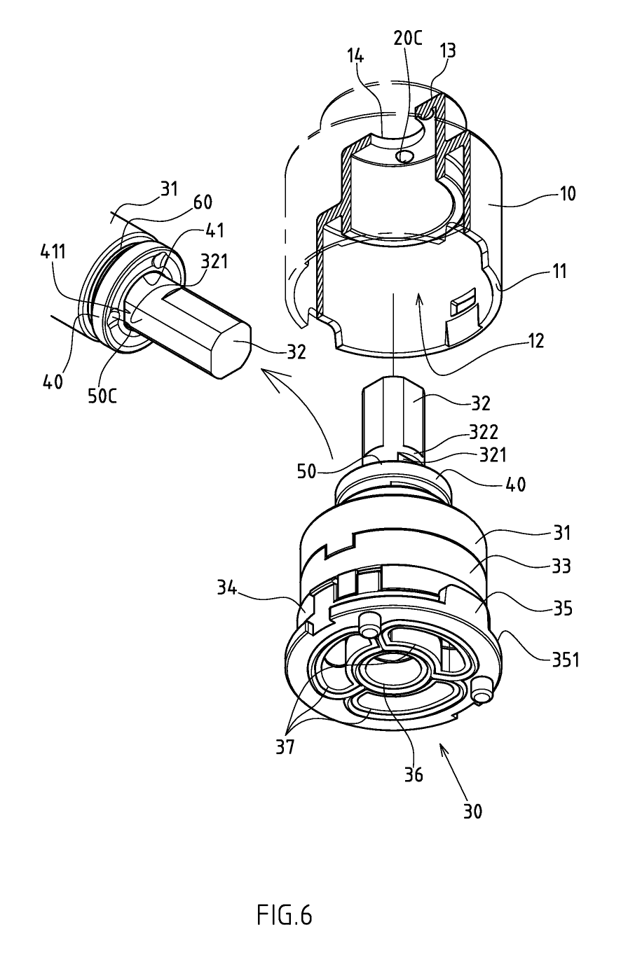

Referring to FIG. 6, the segmented positioning portion 50C is designed into a dotted groove pattern, and the segmented coupling portion 20C is designed into an embossed pattern, so that the segmented positioning portion 50C and the segmented coupling portion 20C could be correspondingly interlocked.

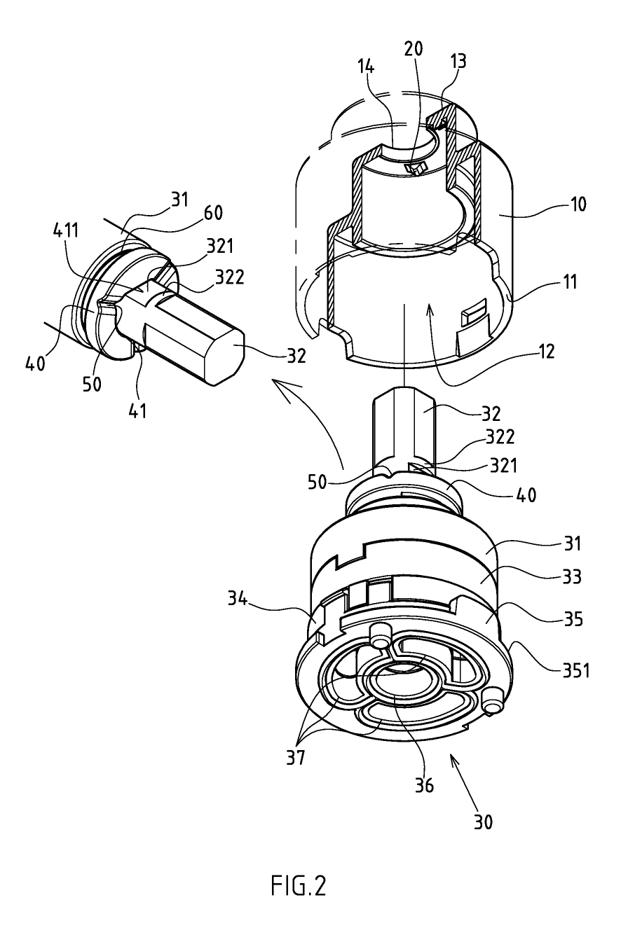

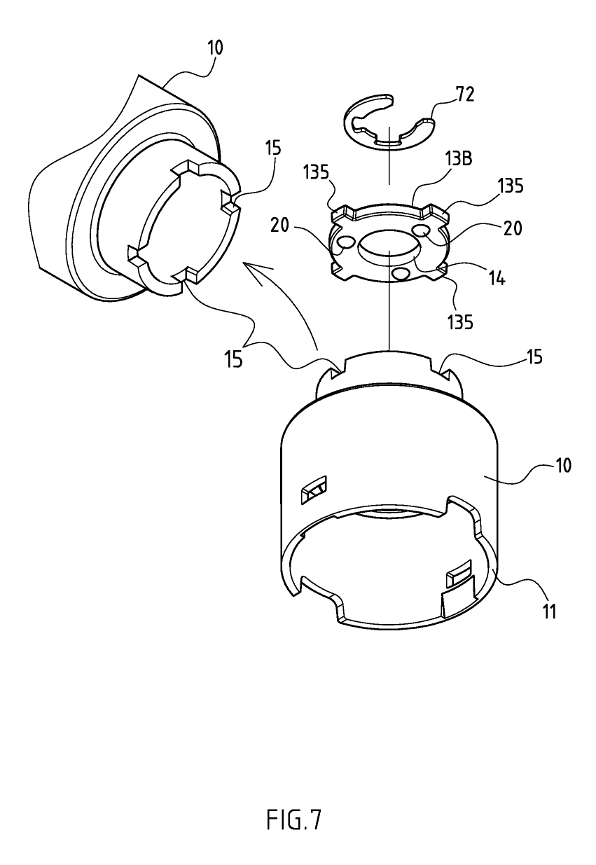

Referring to FIG. 2, an integrated structure could be designed between the shell 10 and the upper end surface 13, namely, the upper end surface 13 is integrally extended from the shell 10. Or, referring to FIG. 7, the upper end surface 13B located on the top of the shell 10 is designed into a combined pattern, so that at least a positioning flange 135 could be protruded on the periphery of the upper end surface 13B, and at least a positioning groove 15 is correspondingly located on the top of the shell 10 for interlocking with the positioning flange 135.

Based on above-specified structure, the present invention is operated as follows:

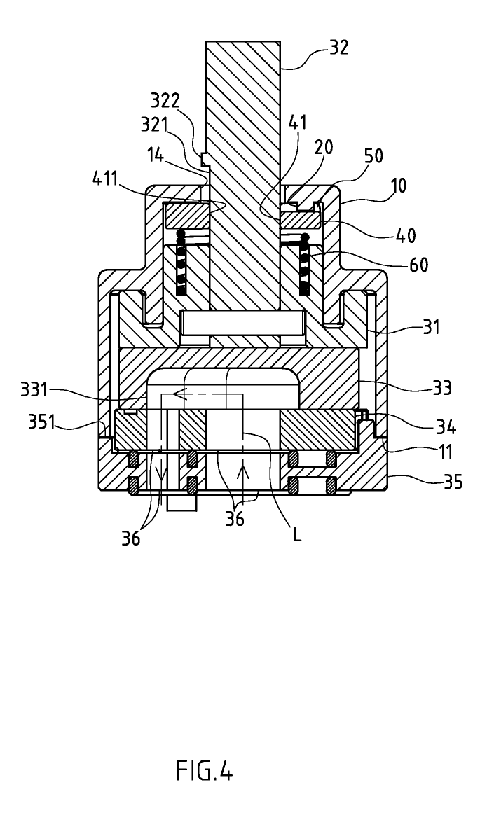

Referring to FIG. 4, the segmented positioning structure of the ceramic shunt valve is operated in a way that the segmented positioning plate 40 is braced via elastic supporting member 60, and the segmented positioning portion 50 is interlocked with the segmented coupling portion 20. When the braking shaft lever 32 is rotated to regulate water diversion direction, the segmented positioning plate 40 could be rotated along with the braking shaft lever 32, allowing for separation of the segmented positioning portion 50 and segmented coupling portion 20 originally interlocked. When the braking shaft lever 32 is rotated to a preset angle, the segmented positioning portion 50 and the segmented coupling portion 20 will be interlocked again. With the vibration, sound or resistance caused by interlocking of the segmented positioning portion 50 and segmented coupling portion 20, it is possible to judge if water diversion is regulated accurately.

When regulating water diversion direction, the rotational valve plate 33 is driven for synchronous rotation by rotating the braking shaft lever 32 to a preset angle. So water streams to be diverted could enter via water inlet 36 (shown by L in FIG. 4) and then flow out as per preset direction via water outlet 36 through the flow channel 331 of the rotational valve plate 33.

1. A segmented positioning structure of a ceramic shunt valve comprising:
a shell, wherein a bottom edge is formed at its bottom and a holding space formed internally; and an upper end surface with a through-hole is set on the top of the shell;
a plurality of segmented coupling portions, arranged at interval onto the inner side of the upper end surface of the shell in an annular pattern;
a water segregator, whose upper end is provided with a rotational positioning seat, and a braking shaft lever is installed on the top end surface; at least a locating rod is set on the periphery of the braking shaft lever, with the bottom connected to a rotational valve plate; a spacing edge is located beside the locating rod; the lower end surface of the rotational valve plate is abutted with a fixed valve plate to form a flow channel; a water inlet is installed on the end surface of the fixed valve plate, and at least two water outlets are set on the periphery of the water inlet; a pedestal located on the bottom of the water segregator is abutted with fixed valve plate; an upper flange arranged on the upper end of the pedestal is interlocked with the bottom edge of the shell, so that the water segregator could be installed in the holding space; a water inlet and a water outlet correspondingly to the fixed valve plate are set on the bottom of the pedestal;
a segmented positioning plate, with a directional sleeved hole opened centrally for assembly on the locating rod of the braking shaft lever; so the segmented positioning plate could rotate along with the braking shaft lever; and desired limitation effect could be achieved through the spacing edge located on the locating rod;
a plurality of segmented positioning portions, set at interval on the segmented positioning plate in annular pattern for embedding into the segmented coupling portion of the shell;
an elastic supporting member, installed between the rotational positioning seat of the water segregator and the segmented positioning plate, so that the segmented positioning plate is elastically supported in an elastic floating state;
when the braking shaft lever is rotated to a preset angle for regulating the water diversion direction, the segmented positioning plate is in a floating state under the elastic bracing of elastic supporting member, in tune with the interlocking and disengagement state of the segmented positioning portion and segmented coupling portion.

2. The structure defined in claim 1, wherein the segmented positioning portion has a radial concave pattern by taking the segmented positioning plate as its center, and the segmented coupling portion has a radial convex pattern by taking the through-hole of the shell as its center, so that the segmented positioning portion and the segmented coupling portion could be correspondingly interlocked.

3. The structure defined in claim 1, wherein the segmented positioning portion has a radial double-convex pattern by taking the segmented positioning plate as its center, and the segmented coupling portion is designed into a radial convex pattern by taking the through-hole of the shell as its center, so that the segmented positioning portion and the segmented coupling portion could be correspondingly interlocked.

4. The structure defined in claim 1, wherein the segmented positioning portion has a dotted groove pattern, and the segmented coupling portion has an embossed pattern, so that the segmented positioning portion and the segmented coupling portion could be correspondingly interlocked.

5. The structure defined in claim 1, wherein an integrated structure is provided between the shell and the upper end surface.

6. The structure defined in claim 1, wherein the upper end surface located on the top of shell has a combined pattern, so that at least a positioning flange could be protruded on the periphery of the upper end surface, and at least a positioning groove is correspondingly located on the top of the shell for interlocking with the positioning flange.
